(19) United States
(12) Patent Application Publication
(10) Pub. No.: US 2018/0343688 A1
(43) Pub. Date: Nov. 29, 2018

(54) WIRELESS COMMUNICATION SYSTEM AND GUARD TERMINAL

(71) Applicants: Sharp Kabushiki Kaisha, Sakai City, Osaka (JP); OSAKA UNIVERSITY, Suita-shi, Osaka (JP)

(72) Inventors: Osamu NAKAMURA, Sakai City (JP); Jungo GOTO, Sakai City (JP); Yasuhiro HAMAGUCHI, Sakai City (JP); Shinichi MIYAMOTO, Suita-shi (JP); Seiichi SAMPEI, Suita-shi (JP); Shinsuke IBI, Suita-shi (JP)

(21) Appl. No.: 15/552,611

(22) PCT Filed: Feb. 23, 2016
(86) PCT No.: PCT/JP2016/055230

§ 371 Date: Aug. 22, 2017

(30) Foreign Application Priority Data
Feb. 23, 2015 (JP) 2015-032629

(51) Int. Cl. H04W 76/10; H04L 9/08; H04L 12/24

(52) U.S. Cl. CPC H04W 76/10; H04L 41/50; H04L 9/083

(57) ABSTRACT

In a wireless communication system that includes a first access point and a guard terminal, the guard terminal transmits a signal for a reservation of a transmission medium after receiving a reservation medium signal transmitted from the first access point and the guard terminal transmits a signal for a reservation of the transmission medium after receiving a reservation medium signal transmitted from a second access point that is different from the first access point.

### TECHNICAL FIELD

The present invention relates to a wireless communication system and a guard terminal.

This application is based upon and claims the benefit of priority of the prior Japanese Patent Application No. 2015-032629, filed in Japan on Feb. 23, 2015, the entire contents of which are incorporated herein by reference.

### BACKGROUND ART

As wireless networks in which unlicensed bands are used, IEEE 802.11 wireless local area networks (LAN) have become widespread. For wireless LAN systems, efficient medium reservation schemes and the like have been investigated for sharing of an unlicensed band with other wireless LAN systems or the like in carrier sense multiple access/collision avoidance (CSMA/CA) scheme (NPL 1, for instance).

In homes and the like, wireless LANs are constructed in order to be used as private networks. In commercial facilities such as shops, shopping malls, and stadiums, wireless LANs are constructed in order to be opened to customers or in order to be used for business operations of the commercial facilities.

Furthermore, portable-type wireless LAN access points (base stations) that are capable of accessing the Internet and the like through mobile wireless communication networks and mobile phone terminals such as smartphones that have a tethering function of functioning as a wireless LAN access point also have become widespread.

### CITATION LIST

### Non-Patent Document

[NON-PATENT DOCUMENT 1] Junya Muneta, Shinichi Miyamoto, Seiichi Sampei, Wenjie Jiang, “A Proposal of Efficient Medium Reservation Scheme for Intra-BSS Centralized WLAN Systems”, IEICE technical report, RSC2014-263, December 2014.

### DISCLOSURE OF THE INVENTION

### Problems to be Solved by the Invention

Wireless communication systems such as the wireless LAN, however, have a problem in that, in cases of sharing of frequency resources with other wireless communication systems existing in the same transmission space, transmission performance of the own wireless communication system may be dependent on existence or absence of other wireless communication systems and amounts of traffic so that stable communication quality may not be ensured.

The invention has been produced in consideration of such circumstances. An object of the invention is to provide a wireless communication system and a guard terminal by which influence of other wireless communication systems existing in the same transmission space can be reduced so that stable communication quality can be obtained.

### Means for Solving the Problems

(1) The present invention has been produced in order to settle the problems described above. An aspect of the invention is a wireless communication system that includes a first access point and a guard terminal, the wireless communication system characterized in that the guard terminal transmits a signal for a reservation of a transmission medium after receiving a reservation medium signal transmitted from the first access point and in that the guard terminal transmits a signal for a reservation of the transmission medium after receiving a reservation medium signal transmitted from a second access point that is different from the first access point.

(2) Another aspect of the invention is the wireless communication system according to (1), the wireless communication system characterized in that the guard terminal preferentially transmits the signal for the reservation of the transmission medium that is based on the reservation medium signal transmitted from the first access point.

(3) Another aspect of the invention is the wireless communication system according to (1), the wireless communication system characterized in that the guard terminal sets a longer duration as a duration for which the medium is to be reserved in a transmission of the signal for the reservation of the transmission medium that is based on the reservation medium signal transmitted from the first access point than in a transmission of the signal for the reservation of the transmission medium that is based on the reservation medium signal transmitted from the second access point.

(4) Another aspect of the invention is the wireless communication system according to (1), the wireless communication system characterized in that the guard terminal transmits the signal for the reservation of the transmission medium that is based on the reservation medium signal transmitted from the first access point in a case of coincidence between transmission timing for the signal for the reservation of the transmission medium that is based on the reservation medium signal transmitted from the first access point and transmission timing for the signal for the reservation of the transmission medium that is based on the reservation medium signal transmitted from the second access point.

(5) Another aspect of the invention is a guard terminal that is used in a wireless communication system including a first access point and the guard terminal, the guard terminal characterized in that the guard terminal transmits a signal for a reservation of a transmission medium after receiving a reservation medium signal transmitted from the first access point and in that the guard terminal transmits a signal for a reservation of the transmission medium after receiving a reservation medium signal transmitted from a second access point that is different from the first access point.

(6) Another aspect of the invention is the guard terminal according to (5), the guard terminal characterized in that the guard terminal preferentially transmits the signal for the reservation of the transmission medium that is based on the reservation medium signal transmitted from the first access point.

(7) Another aspect of the invention is the guard terminal according to (5), the guard terminal characterized in that the guard terminal sets a longer duration as a duration for which the medium is to be reserved in a transmission of the signal for the reservation of the transmission medium that is based on the reservation medium signal transmitted from the first access point than in a transmission of the signal for the reservation of the transmission medium that is based on the reservation medium signal transmitted from the second access point.

(8) Another aspect of the invention is the guard terminal according to (5), the guard terminal characterized in that the guard terminal transmits the signal for the reservation of the transmission medium that is based on the reservation medium signal transmitted from the first access point in a case of coincidence between transmission timing for the signal for the reservation of the transmission medium that is based on the reservation medium signal transmitted from the first access point and transmission timing for the signal for the reservation of the transmission medium that is based on the reservation medium signal transmitted from the second access point.

### Effects of the Invention

According to the present invention, influence of other wireless communication systems existing in the same transmission space can be reduced so that stable communication quality can be obtained.

### BRIEF DESCRIPTION OF THE DRAWINGS

FIG. 1 is a schematic diagram illustrating a configuration of a wireless communication system 100 according to a first embodiment of the invention.

FIG. 2 is a frequency distribution illustrating an example of usage of channels in the embodiment.

FIG. 3 is a frequency distribution illustrating another example of usage of the channels in the embodiment.

FIG. 4 is a timing diagram illustrating an example of transmission timing for CTS in the embodiment.

FIG. 5 is a schematic block diagram illustrating a configuration of an access point 10 in the embodiment.

FIG. 6 is a schematic block diagram illustrating a configuration of a guard terminal 20a in the embodiment.

FIG. 7 is a schematic block diagram illustrating a configuration of a terminal apparatus 40a in the embodiment.

FIG. 8 is a flow chart for description on processing related to transmissions of the CTS in the access point 10 in the embodiment.

FIG. 9 is a flow chart for description on processing related to transmissions of the CTS in the guard terminal 20a in the embodiment.

FIG. 10 is a schematic diagram illustrating a configuration of a wireless communication system 100-1 according to a second embodiment of the invention.

FIG. 11 is a schematic block diagram illustrating a configuration of the guard terminal 20a in the embodiment.

FIG. 12 is a schematic block diagram illustrating a configuration of a monitoring terminal 30a in the embodiment.

FIG. 13 is a flow chart for description on processing related to control over transmitted power from the guard terminal 20a in the embodiment.

FIG. 14 is a schematic block diagram illustrating a configuration of the access point 10 according to a third embodiment of the invention.

FIG. 15 is a schematic block diagram illustrating a configuration of the guard terminal 20a in the embodiment.

FIG. 16 is a flow chart for description on processing related to transmissions of the CTS in the guard terminal 20a in the embodiment.

FIG. 17 is a timing diagram illustrating an example of transmission timing for the CTS in the embodiment.

FIG. 18 is a timing diagram illustrating another example of transmission timing for the CTS in the embodiment.

### MODE FOR CARRYING OUT THE INVENTION

### First Embodiment

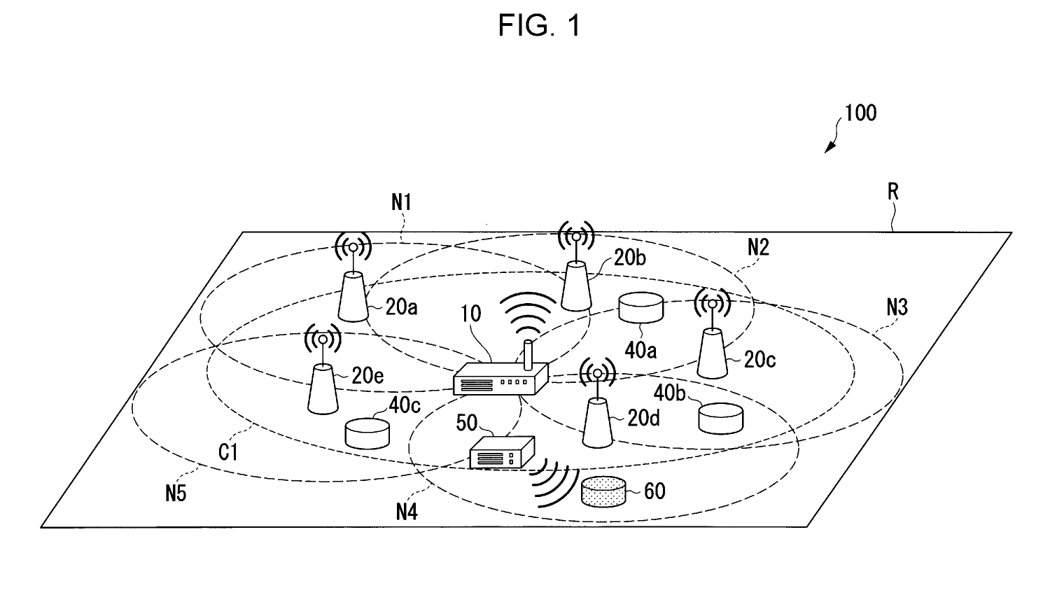

Hereinbelow, a first embodiment of the invention will be described with reference to the drawings. FIG. 1 is a schematic diagram illustrating a configuration of a wireless communication system 100 according to the first embodiment of the invention. The wireless communication system 100 is a wireless LAN constructed in a space R an owner owns. The wireless communication system 100 has a channel dedicated to the owner. The wireless communication system 100 includes an access point 10, guard terminals 20a, 20b, 20c, 20d, and 20e, and terminal apparatuses 40a, 40b, and 40c. The wireless communication system 100 has only to include at least one access point and may include a plurality of access points. Similarly, the wireless communication system 100 has only to include at least one guard terminal. The wireless communication system 100 may include no terminal apparatus.

Communication ranges C1, N1, N2, N3, N4, and N5 are communication ranges of the access point 10 and the guard terminals 20a, 20b, 20c, 20d, and 20e, respectively.

In FIG. 1, a visitor to the space R has brought in an access point (AP) 50 and a terminal apparatus (station (STA)) 60. The access point 10 and the guard terminals (guard stations (G-STA)) 20a, 20b, 20c, 20d, and 20e transmit clear to send (CTS) with setting of a duration of transmission prohibition, that is, a duration for which a communication medium is reserved, to surroundings through the dedicated channel so that the access point 50 and the terminal apparatus 60 of the visitor may not communicate with use of the dedicated channel Herein, the CTS is one of signals (medium reservation signals) that are transmitted for ensuring (reservation) of a communication medium (radio resource). The CTS may be CTS to self in which a MAC address of the own apparatus is set in a receiver address (RA) field, for instance. In that case, the access point 10 transmits the CTS in which the MAC address of the access point 10 is set in the RA field and the guard terminal 20a transmits the CTS in which the MAC address of the guard terminal 20a is set in the RA field. The CTS may be CTS in which a predetermined MAC address is set in the RA field, for instance. The predetermined MAC address may be common or may not be common among the access point 10 and the guard terminals 20a, 20b, 20c, 20d, and 20e.

The guard terminals 20a, 20b, 20c, 20d, and 20e are placed so that the communication ranges N1, N2, N3, N4, and N5 of the guard terminals 20a, 20b, 20c, 20d, and 20e cover positions from which communication that might be made by the access point 50 and the terminal apparatus 60 might interfere with terminal apparatuses in the communication range of the access point 10. Otherwise, the guard terminals 20a, 20b, 20c, 20d, and 20e are placed so that the communication ranges N1, N2, N3, N4, and N5 of the guard terminals 20a, 20b, 20c, 20d, and 20e may cover the space R as much as possible.

Though use of an omni antenna that transmits radio waves in all directions is assumed for each of the guard terminals in the embodiment, efficient occupation of the space is enabled by transmissions of radio waves in a specified direction (particularly in a direction opposite to a position of the AP) with use of a directional antenna, beamforming by a precoder, or the like.

Upon detection of the CTS, the access point 50 and the terminal apparatus 60 set the duration for which the transmission prohibition is set, as a network allocation vector (NAV), and carry out deferral of transmissions in the NAV, communication with selection of a channel other than the dedicated channel through dynamic frequency selection (DFS) function, or the like.

Meanwhile, the terminal apparatuses 40a, 40b, and 40c communicate with the access point 10 in the duration for which the transmission prohibition is set, even upon detection of the CTS through the dedicated channel The terminal apparatuses 40a, 40b, and 40c may communicate with the access point 10 in the duration for which the transmission prohibition is set, in response to the CTS in which a predetermined MAC address (including an address of an apparatus other than the own apparatus) is set in the RA field or may communicate with the access point 10 in the duration for which the transmission prohibition is set, irrespective of the MAC address set in the RA field. The communication may be made with change in clear channel assessment (CCA) level. As the CCA level, power for determination of start of communication is changed in accordance with magnitude of transmitted power of a received signal. For instance, a terminal set at −30 dBm is capable of obtaining more transmission opportunities than a terminal set at −82 dBm.

Thus the access point 10 and the guard terminals 20a, 20b, 20c, 20d, and 20e transmit the CTS through the dedicated channel so that apparatuses which communicate through the dedicated channel in the communication ranges C1, N1, N2, N3, N4, and N5 can be limited to only the access point 10 and the terminal apparatuses 40a, 40b, and 40c.

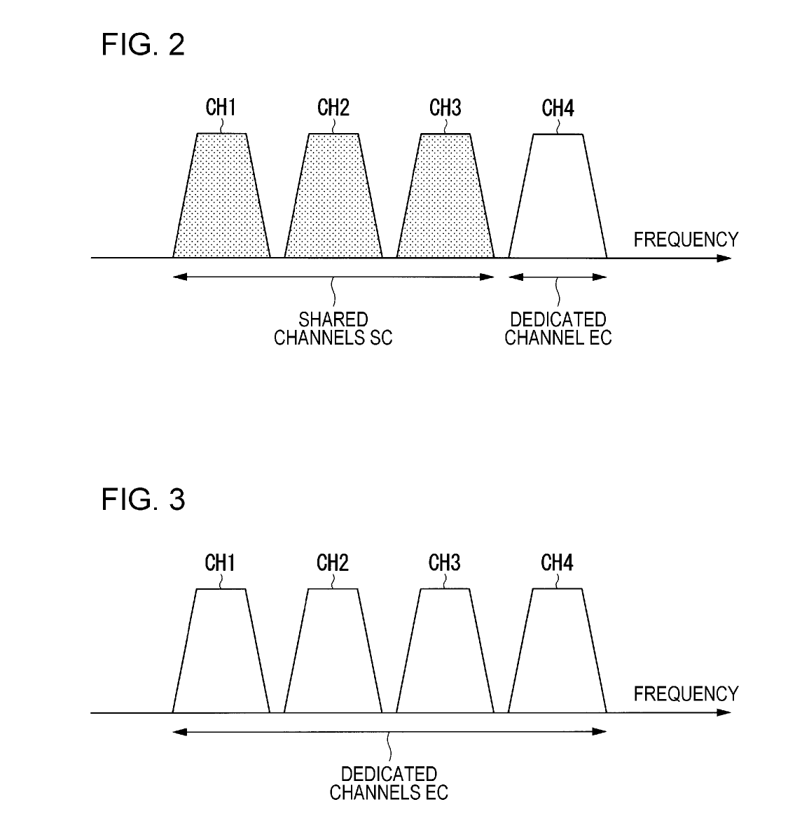

FIG. 2 is a frequency distribution illustrating an example of usage of channels in the embodiment. In FIG. 2, a horizontal axis represents frequencies. Among channels CH1, CH2, CH3, and CH4 that are used in the space R, only the channel CH4 is the dedicated channel EC. The remaining channels CH1, CH2, and CH3 are shared channels SC. That is, the access point 10 and the guard terminals 20a, 20b, 20c, 20d, and 20e transmit the CTS through the channel CH4 and the access point 10 and the terminal apparatuses 40a, 40b, and 40c make communication through the channel CH4. Meanwhile, the access point 50 and the terminal apparatus 60 make communication by use of at least one channel among the channels CH1, CH2, and CH3 that are the shared channels SC.

The channels may be referred to as frequency channels, subchannels, component carriers, or the like and a communication system can independently be constructed only with use of a band of each channel. A bandwidth of each channel may be referred to as a system band.

FIG. 3 is a frequency distribution illustrating another example of usage of the channels in the embodiment.

In FIG. 3, all of the channels CH1, CH2, CH3, and CH4 are dedicated channels EC.

In another example, though illustration is omitted, a plurality of channels such as the channels CH1 and CH4 may be dedicated channels EC and the remaining channels CH2 and CH3 may be shared channels SC. In case where the dedicated channels EC are made of a plurality of channels, the access point 10 and the guard terminals 20a, 20b, 20c, 20d, and 20e transmit the CTS through the plurality of channels.

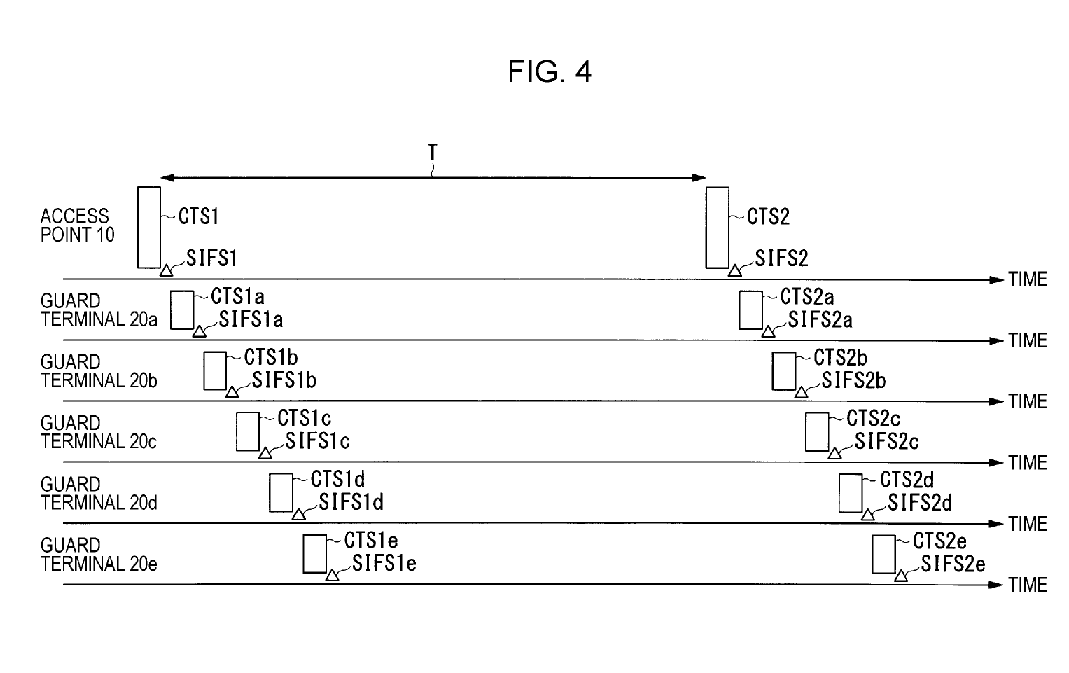

FIG. 4 is a timing diagram illustrating an example of transmission timing for the CTS in the embodiment. In the timing diagram of FIG. 4, a horizontal axis represents time. Initially, the access point 10 transmits a CTS frame CTS1 in which a duration T is set as the duration of the transmission prohibition. After a lapse of a predetermined duration SIFS1 that is referred to as short interframe space (SIFS) from detection of the frame CTS1, the guard terminal 20a transmits a CTS frame CTS1a in which the duration T is set as the duration of the transmission prohibition. After a lapse of a predetermined duration SIFS1a that is referred to as short interframe space (SIFS) from detection of the frame CTS1a, the guard terminal 20b transmits a CTS frame CTS1b in which the duration T is set as the duration of the transmission prohibition. The guard terminals 20c, 20d, and 20e iteratively carry out a similar operation.

After a lapse of the duration T from a transmission of the CTS frame CTS1, the access point 10 transmits a CTS frame CTS2 in which the duration T is similarly set as the duration of the transmission prohibition. Then the guard terminals 20a, 20b, 20c, 20d, and 20e iterate operations similar to those at time of the transmission of the frame CTS1. Subsequently, the access point 10 and the guard terminals 20a, 20b, 20c, 20d, and 20e similarly iterate transmissions of CTS frames. The access point 10 makes communication using the dedicated channels EC with the terminal apparatuses 40a, 40b, and 40c between the transmissions of the CTS frames.

Though the example in which intervals between the CTS frame transmissions iterated by the access point 10 are the same as the duration T of prohibition against transmission that is set in the CTS has been described, the intervals may differ from the duration T. For instance, the intervals between the iterated CTS frame transmissions may be set longer than the duration T of prohibition against transmission that is set in the CTS, so that time durations that are not dedicated but shared may be provided for the dedicated channels EC. The access point 10 may set the intervals between the iterated CTS frame transmissions or the duration of prohibition against transmission so that the greater a detection frequency for signals from other networks is, the greater a value obtained by subtraction of the transmission prohibition duration from the intervals of the iterated CTS frame transmissions may be, for instance.

Though a number of the guard terminals that transmit the CTS frame upon the detection of the CTS frame from the access point 10 or each guard terminal is one in FIG. 4, the number may be more than one. For instance, the guard terminals that transmit the CTS frame upon the detection of the CTS frame from the access point 10 may be two guard terminals, that is, the guard terminal 20a and the guard terminal 20d. Such a configuration makes a plurality of guard terminals transmit the CTS frame at the same time. It is desirable, however, for the communication ranges of the guard terminals not to overlap.

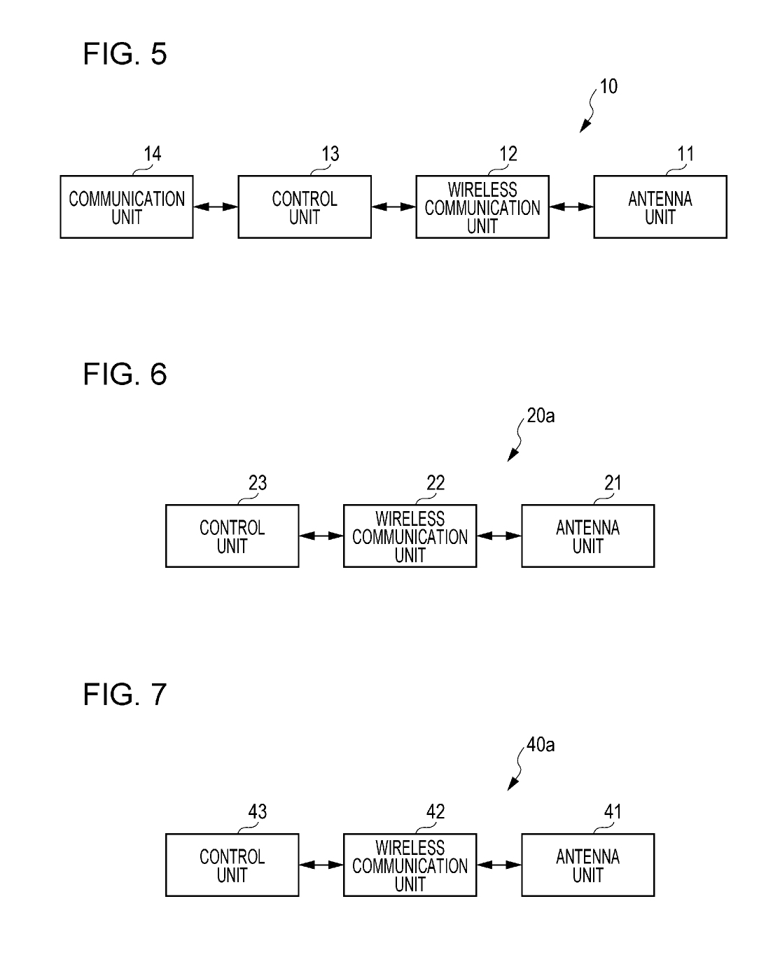

FIG. 5 is a schematic block diagram illustrating a configuration of the access point 10. The access point 10 includes an antenna unit 11, a wireless communication unit 12, a control unit 13, and a communication unit 14. The antenna unit 11 transmits and receives signals of frames for the wireless LAN through the dedicated channels EC. The antenna unit 11 may transmit and receive the signals of the frames for the wireless LAN through the shared channels SC as well. The wireless communication unit 12 modulates and demodulates the signals of the frames for the wireless LAN that are transmitted and received through the antenna unit 11. Additionally, the wireless communication unit 12 carries out processing in accordance with protocols of the wireless LAN. The control unit 13 makes conversion between the frames for the wireless LAN that are transmitted and received through the wireless communication unit 12 and frames for Ethernet® that are transmitted and received through the communication unit 14. The control unit 13 periodically transmits the CTS frames through the wireless communication unit 12 and the antenna unit 11. The communication unit 14 is connected to other instruments through Ethernet® and modulates and demodulates signals of the frames for Ethernet®.

FIG. 6 is a schematic block diagram illustrating a configuration of the guard terminal 20a. The guard terminals 20a, 20b, 20c, 20d, and 20e have similar configurations and description on the guard terminals 20b, 20c, 20d, and 20e is therefore omitted. The guard terminal 20a includes an antenna unit 21, a wireless communication unit 22, and a control unit 23. The antenna unit 21 transmits and receives signals of the CTS frames through the dedicated channels EC. The wireless communication unit 22 modulates and demodulates the signals of the CTS frames that are transmitted and received through the antenna unit 21. When the control unit 23 receives a specified CTS frame through the wireless communication unit 22, the control unit 23 transmits a CTS frame through the wireless communication unit 22.

FIG. 7 is a schematic block diagram illustrating a configuration of the terminal apparatus 40a. The terminal apparatuses 40a, 40b, and 40c have similar configurations and description on the terminal apparatuses 40b and 40c is therefore omitted. The terminal apparatus 40a includes an antenna unit 41, a wireless communication unit 42, and a control unit 43. The antenna unit 41 transmits and receives the signals of the frames for the wireless LAN through the dedicated channels EC. The wireless communication unit 42 modulates and demodulates the signals of the frames for the wireless LAN that are transmitted and received through the antenna unit 41. Additionally, the wireless communication unit 42 carries out processing in accordance with the protocols of the wireless LAN. The control unit 43 carries out execution processing for applications, processing for higher layers such as/IP, or the like and transmits and receives the frames for the wireless LAN through the wireless communication unit 42.

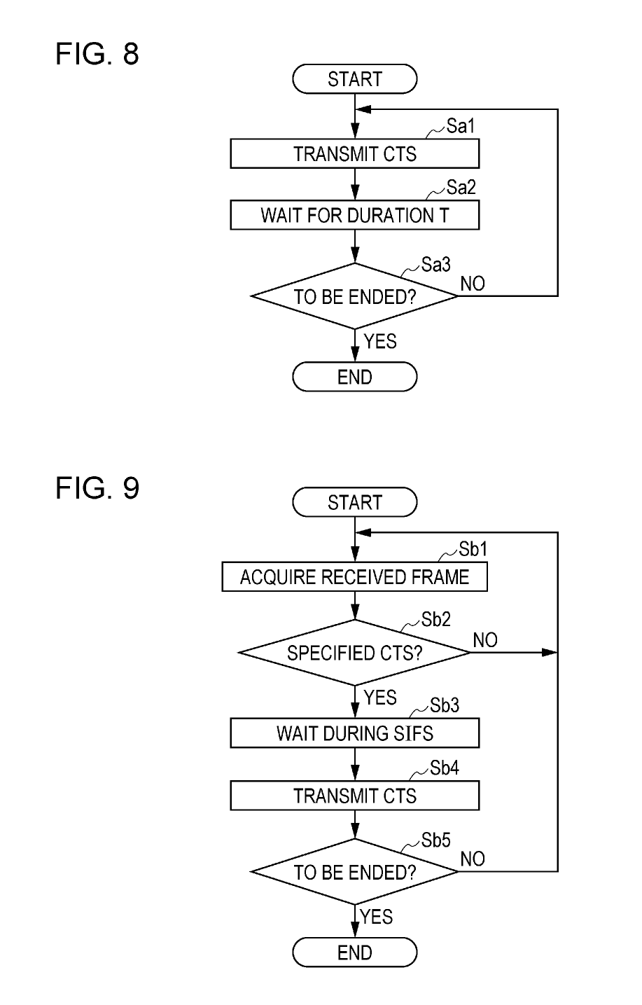

FIG. 8 is a flow chart for description on processing related to the transmissions of the CTS in the access point 10. The control unit 13 initially instructs the wireless communication unit 12 to transmit a CTS frame. The wireless communication unit 12 generates a signal by modulating the CTS frame and transmits the signal through the antenna unit 11 (Sa1). Subsequently, the control unit 13 waits for the duration T (Sa2). Subsequently, the control unit 13 ends the processing if the processing is to be ended for power-off or the like (Sa3-Y). On the other hand, if the processing is to be continued without being ended (Sa3-N), the control unit 13 returns to processing of step Sa1.

FIG. 9 is a flow chart for description on processing related to the transmissions of the CTS in the guard terminal 20a.

Hereinbelow, the same applies to processing in the guard terminals 20b, 20c, 20d, and 20e, unless otherwise stated. The control unit 23 initially acquires a received frame received by the wireless communication unit 22 through the antenna unit 21 and demodulated by the wireless communication unit 22 (Sb1). Subsequently, the control unit 23 determines whether the received frame is a specified CTS frame or not (Sb2). Herein, the specified CTS frame refers to a CTS frame in which a predetermined MAC address is set in the RA field, for instance. The predetermined MAC address for the guard terminal 20a is the MAC address of the access point 10, for instance. The predetermined MAC address for the guard terminal 20b is the MAC address of the guard terminal 20a, for instance.

If it is determined in step Sb2 that the received frame is not the specified CTS frame (Sb2-N), the control unit 23 returns to processing of step Sb1. On the other hand, if it is determined in step Sb2 that the received frame is the specified CTS frame (Sb2-Y), the control unit 23 waits during the SIFS (Sb3). Subsequently, the control unit 23 instructs the wireless communication unit 22 to transmit a CTS frame through the antenna unit 21. The control unit 23 instructs that a predetermined MAC address such as the MAC address of the own apparatus should be set in the RA field of the CTS frame. Pursuant to instructions from the control unit 23, the wireless communication unit 22 generates a signal by modulating the CTS frame and transmits the signal through the antenna unit 21 (Sb4). Subsequently, the control unit 23 ends the processing if the processing is to be ended for power-off or the like (Sb5-Y). On the other hand, if the processing is to be continued without being ended (Sb5-N), the control unit 23 returns to the processing of step Sb1.

In the embodiment described above, the apparatuses may each transmit a signal of a request to send (RTS) frame that is one of the medium reservation signals, in place of the signal of the CTS frame, as a signal for reserving of the dedicated channels EC. In this case, the guard terminals 20a to 20e may refer to a transmitter address (TA) field of the RTS frame in place of the RA field of the CTS frame in step Sb2 of FIG. 8, for instance.

The access point 10 may instruct the guard terminals 20a to 20e on timing at which the guard terminals 20a to 20e each transmit the CTS frame. For instance, the guard terminals 20a to 20e may each be notified in advance, by the access point 10, of the MAC address that is to be set in the RA field of the CTS frame to be transmitted and, if the MAC address of the own apparatus is set in the RA field of a CTS frame another guard terminal transmits, the guard terminals 20a to 20e may transmit the CTS frame after waiting during the SIFS. In another example, the guard terminals 20a to 20e may wait during the SIFS and may then transmit the CTS frame, after detecting the CTS from another guard terminal in which a specified MAC address is set in the TA field as a trigger for a transmission of the CTS frame. In this case, the guard terminals 20a to 20e may each be notified of the specified MAC address by the access point 10.

In the embodiment described above, communication between the access point 10 and the terminal apparatuses 40a, 40b, and 40c may be communication that does not comply with any of IEEE 802.11. Alternatively, the access point 10 and the terminal apparatuses 40a, 40b, and 40c may make communication that does not comply with any of IEEE 802.11 in time durations reserved by the signals for reserving the dedicated channels EC and may make communication that complies with any of IEEE 802.11 in time durations not reserved.

Thus the access point 10 transmits the signals for reserving the dedicated channels EC and the terminal apparatuses 40a, 40b, and 40c make communication through the reserved dedicated channels EC as well. As a result, the communication through the dedicated channels EC can be made without being interfered by other apparatuses.

The guard terminals may operate as guard terminals for a plurality of access points.

The guard terminals that receive medium reservation signals transmitted from the plurality of access points and that operate as the guard terminals therefor may enable efficiently use of the space.

In cases where the guard terminals operate as guard terminals for a plurality of access points, priority may be set for the access points. Giving the priority to more important wireless communication systems makes it possible to set priority in communication more flexibly.

The priority may be set by change in a length of the duration for which the communication medium is reserved (the higher the priority is, the longer the duration may be, for instance) or may be set so as to be given to one access point in case where timing of reservations of the communication medium for a plurality of access points coincides. That is, in case where the timing of the reservations of the communication medium for the plurality of access points coincides, a signal for reserving the communication medium for an access point having higher priority may be transmitted through a wire.

### Second Embodiment

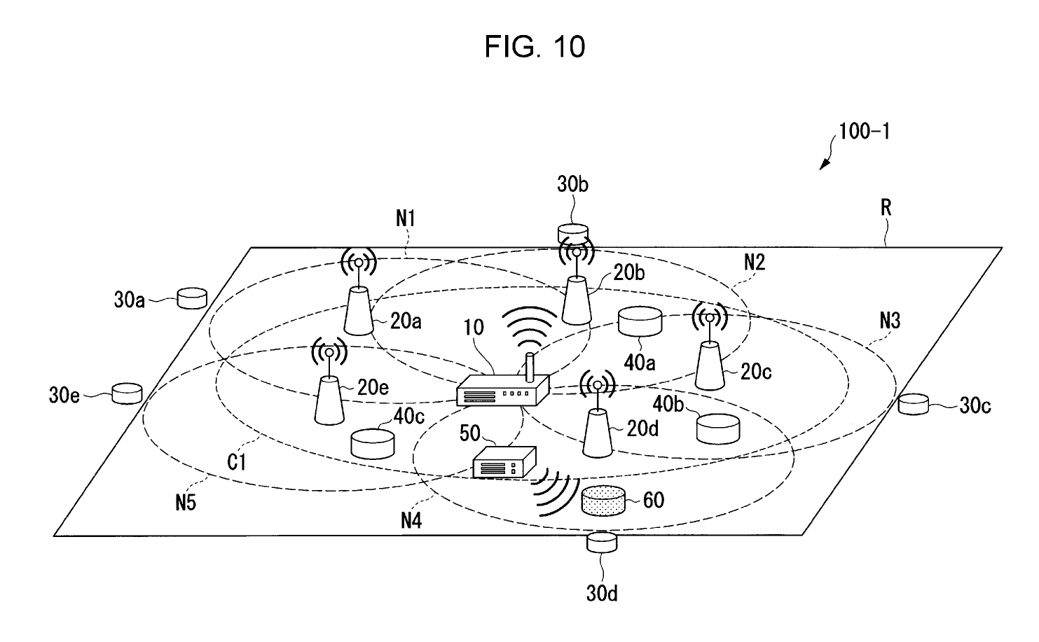

Hereinbelow, a second embodiment of the invention will be described with reference to the drawings. FIG. 10 is a schematic diagram illustrating a configuration of a wireless communication system 100-1 according to the second embodiment of the invention. The wireless communication system 100-1 of FIG. 10 includes the access point 10, the guard terminals 20a, 20b, 20c, 20d, and 20e, monitoring terminals 30a, 30b, 30c, 30d, and 30e, and the terminal apparatuses 40a, 40b, and 40c.

The wireless communication system 100-1 differs from the wireless communication system 100 of FIG. 1 in inclusion of the monitoring terminals 30a, 30b, 30c, 30d, and 30e and in a configuration of the guard terminals 20a, 20b, 20c, 20d, and 20e. Description below will be given chiefly on the guard terminals 20a, 20b, 20c, 20d, and 20e and on the monitoring terminals 30a, 30b, 30c, 30d, and 30e.

The guard terminals 20a, 20b, 20c, 20d, and 20e in the embodiment transmit signals of CTS frames in a manner similar to that in the first embodiment. The guard terminals 20a, 20b, 20c, 20d, and 20e, however, differ from those of the first embodiment in that the guard terminals 20a, 20b, 20c, 20d, and 20e respectively control transmitted power for transmitting the signals of the CTS frames based on measurement results of received power which are provided by the monitoring terminals 30a, 30b, 30c, 30d, and 30e. The monitoring terminals 30a, 30b, 30c, 30d, and 30e are provided in vicinities of a boundary between the space R and outside thereof or, preferably, provided in the vicinities of the boundary between the space R and the outside that are each nearest to the corresponding guard terminal.

The monitoring terminals 30a, 30b, 30c, 30d, and 30e each measure the received power through the dedicated channels EC and respectively give notification to the guard terminals 20a, 20b, 20c, 20d, and 20e. In the embodiment, interference that is caused in the outside of the space R by the signals transmitted by the guard terminals 20a, 20b, 20c, 20d, and 20e is reduced by control over the transmitted power based on the notification.

Though the monitoring terminals 30a, 30b, 30c, 30d, and 30e are communicably connected by wires to the guard terminals 20a, 20b, 20c, 20d, and 20e, respectively, such connection may be attained by another means such as wireless communication through the access point 10 and direct wireless communication. A plurality of monitoring terminals may be connected to one guard terminal and one monitoring terminal may be connected to a plurality of guard terminals.

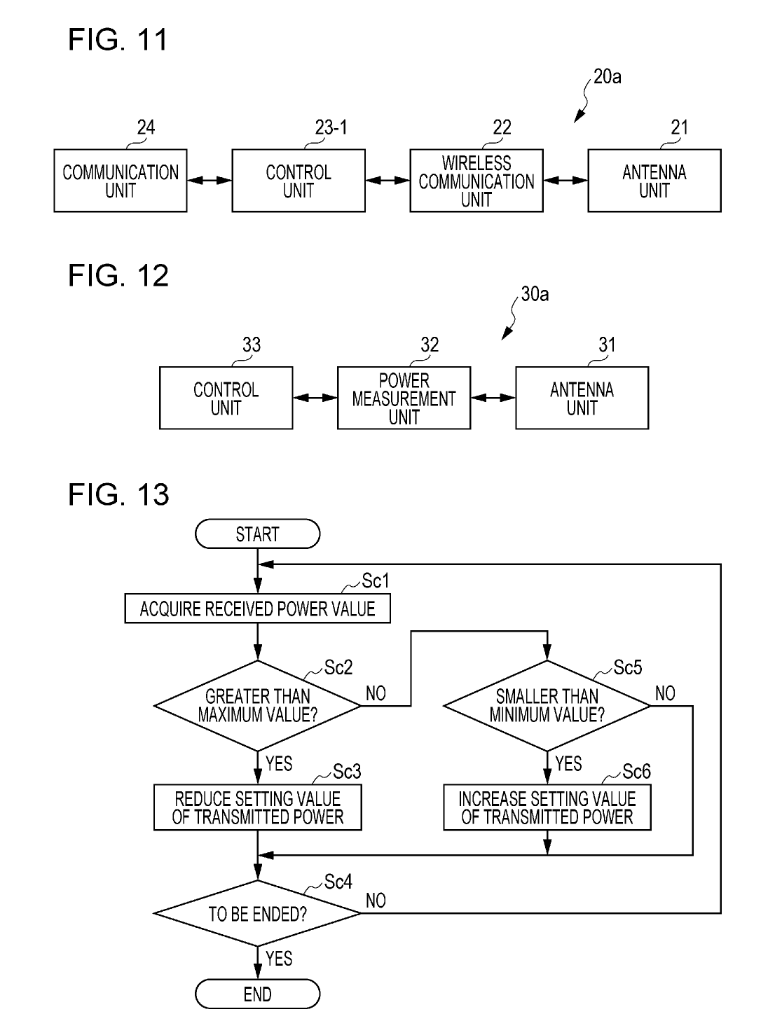

FIG. 11 is a schematic block diagram illustrating the configuration of the guard terminal 20a in the embodiment. The same applies to the configurations of the guard terminals 20b, 20c, 20d, and 20e in the embodiment and description on the configurations is therefore omitted. The guard terminal 20a includes the antenna unit 21, the wireless communication unit 22, a control unit 23-1, and a communication unit 24. The antenna unit 21 and the wireless communication unit 22 are similar to the antenna unit 21 and the wireless communication unit 22 of FIG. 6. The control unit 23-1 differs from the control unit 23 of FIG. 6 in that the control unit 23-1 makes communication with the corresponding monitoring terminal (the monitoring terminal 30a for the guard terminal 20a) through the communication unit 24 and in that the control unit 23-1 acquires values of the received power through the communication and controls the transmitted power for transmitting the signals of the CTS frames, based on the acquired values of the received power. The communication unit 24 is connected to the corresponding monitoring terminal 30a and receives the values of the received power measured by the monitoring terminal 30a from the monitoring terminal 30a.

FIG. 12 is a schematic block diagram illustrating a configuration of the monitoring terminal 30a. Configurations of the monitoring terminals 30b, 30c, 30d, and 30e are similar to the configuration of the monitoring terminal 30a and description on the configurations is therefore omitted. The monitoring terminal 30a includes an antenna unit 31, a power measurement unit 32, and a communication unit 33. The antenna unit 31 receives the signals through the dedicated channels EC. The power measurement unit 32 measures the power of the signals received by the antenna unit 31. The power measurement unit 32 may measure only the power of a signal of a specified CTS frame. The power measurement unit 32 determines whether a signal is of the specified CTS frame or not, by detecting the RA field of the CTS frame and determining whether a value of the RA field is a predetermined MAC address (such as the MAC address of the corresponding guard terminal 20a) or not, for instance. The power measurement unit 32 may measure the received power of the signals in time durations instructed from the corresponding guard terminal 20a. The communication unit 33 is connected to the corresponding guard terminal 20a and transmits the values of the received power measured by the power measurement unit 32.

FIG. 13 is a flow chart for description on processing related to control over the transmitted power from the guard terminal 20a. Hereinbelow, the same applies to processing in the guard terminals 20b, 20c, 20d, and 20e, unless otherwise stated. Initially, the control unit 23-1 acquires a value of the received power from the corresponding monitoring terminal (the monitoring terminal 30a for the guard terminal 20a) through the communication unit 24 (Sc1). Subsequently, the control unit 23-1 determines whether the acquired value of the received power is greater than a preset maximum value or not (Sc2). If the control unit 23-1 determines that the acquired value is greater (Sc2-Y), the control unit 23-1 reduces a setting value of the transmitted power that is set for the wireless communication unit 22 (Sc3). Subsequently, the control unit 23-1 ends the processing if the processing is to be ended for power-off or the like (Sc4-Y). On the other hand, if the processing is to be continued without being ended (Sc4-N), the control unit 23-1 returns to processing of step Sc1.

In addition to the processing of acquiring the value of the received power, processing of counting a number of received CTS, setting specified threshold values, and increasing or decreasing the transmitted power based on the counted number of the CTS may be carried out.

On the other hand, if the control unit 23-1 determines in step Sc2 that the acquired value of the received power is not greater than the maximum value (Sc2-N), the control unit 23-1 determines whether the acquired value of the received power is smaller than a preset minimum value or not (Sc5). If the control unit 23-1 determines that the acquired value is smaller (Sc5-Y), the control unit 23-1 increases the setting value of the transmitted power that is set for the wireless communication unit 22 (Sc6) and proceeds to processing of step Sc4.

On the other hand, if the control unit 23-1 determines in step Sc5 that the acquired value of the received power is not smaller than the minimum value (Sc5-N), the control unit 23-1 proceeds to the processing of step Sc4.

In case where there are a plurality of monitoring terminals corresponding to the guard terminal 20a, values of the received power measured by all the corresponding monitoring terminals are measured in step Sc1 and following processing is carried out for the greatest of the measured values.

In the embodiment, the monitoring terminals 30a, 30b, 30c, 30d, and 30e each measure the received power and the guard terminals 20a, 20b, 20c, 20d, and 20e each determine the transmitted power based on the received power. The monitoring terminals 30a, 30b, 30c, 30d, and 30e, however, may determine the transmitted power.

In the embodiment as well, effects similar to those of the first embodiment can be obtained. Besides, the interference in the outside of the space R that may be caused by the signals transmitted by the guard terminals 20a, 20b, 20c, 20d, and 20e can be reduced by the control over the transmitted power of the guard terminals 20a, 20b, 20c, 20d, and 20e based on the received power measured by the monitoring terminals 30a, 30b, 30c, 30d, and 30e.

### Third Embodiment

Hereinbelow, a third embodiment of the invention will be described with reference to the drawings. A configuration of the wireless communication system 100 according to the third embodiment is similar to that of the wireless communication system 100 according to FIG. 1. The guard terminals 20a, 20b, 20c, 20d, and 20e in the embodiment, however, make millimeter-wave wireless communication with the access point 10. The access point 10 uses the millimeter-wave wireless communication to control the timing at which the guard terminals 20a, 20b, 20c, 20d, and 20e each transmit the signals of the CTS frames.

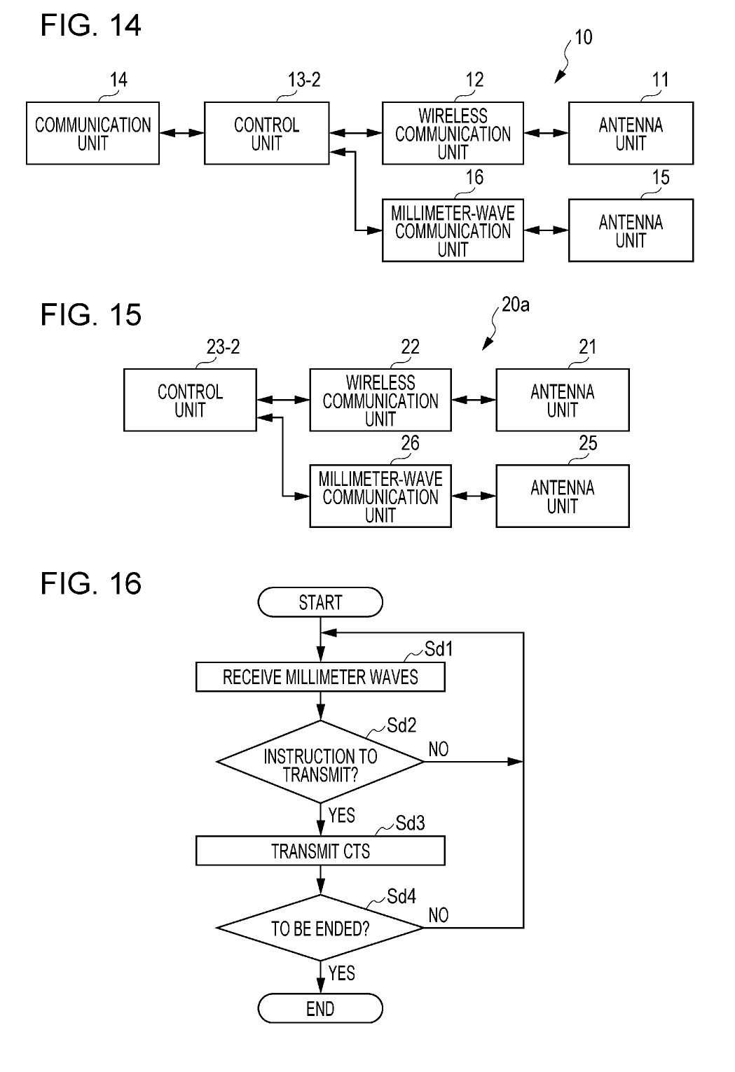

FIG. 14 is a schematic block diagram illustrating a configuration of the access point 10 in the embodiment. The access point 10 includes the antenna unit 11, the wireless communication unit 12, a control unit 13-2, the communication unit 14, an antenna unit 15, and a millimeter-wave communication unit 16. The antenna unit 11, the wireless communication unit 12, and the communication unit 14 are similar to those of FIG. 5 and description on those units is therefore omitted. The antenna unit 15 transmits and receives millimeter-wave signals. The millimeter-wave communication unit 16 modulates and demodulates the signals that are transmitted and received through the antenna unit 15. The control unit 13-2 instructs the millimeter-wave communication unit 16 to make communication with the guard terminals 20a, 20b, 20c, 20d, and 20e through the antenna unit 15. Through the communication, the control unit 13-2 instructs the guard terminals 20a, 20b, 20c, 20d, and 20e on the transmission timing for the CTS.

FIG. 15 is a schematic block diagram illustrating a configuration of the guard terminal 20a in the embodiment. Configurations of the guard terminals 20b, 20c, 20d, and 20e in the embodiment are similar to the configuration of the guard terminal 20a and description on the configurations is therefore omitted. The guard terminal 20a in the embodiment includes the antenna unit 21, the wireless communication unit 22, a control unit 23-2, an antenna unit 25, and a millimeter-wave communication unit 26. The antenna unit 21 and the wireless communication unit 22 are similar to those units of FIG. 6 and description on the units is therefore omitted. The antenna unit 25 transmits and receives the millimeter-wave signals. The millimeter-wave communication unit 26 modulates and demodulates the signals that are transmitted and received through the antenna unit 25. The control unit 23-2 instructs the millimeter-wave communication unit 26 to make communication with the access point 10 through the antenna unit 25. Pursuant to the transmission timing instructed through the communication, the control unit 23-2 instructs the wireless communication unit 22 to transmit a CTS frame.

Herein, the millimeter waves are not mentioned in order to impose limitations on a frequency band that is used for the communication but mentioned in order to represent an example of the frequency band and the frequency band has only to be different from frequency bands that are used for the wireless communication unit 12 and the like.

FIG. 16 is a flow chart for description on processing related to transmissions of the CTS in the guard terminal 20a in the embodiment. Hereinbelow, the same applies to processing in the guard terminals 20b, 20c, 20d, and 20e, unless otherwise stated. The control unit 23-2 initially acquires a received frame received from the access point 10 through the antenna unit 25 by the millimeter-wave communication unit 26 and demodulated by the millimeter-wave communication unit 26 (Sd1). Subsequently, the control unit 23-2 determines whether the acquired received frame is an instruction to transmit CTS or not (Sd2). If the control unit 23-2 determines that the acquired received frame is not the instruction to transmit the CTS (Sd2-N), the control unit 23-2 returns to processing of step Sd1.

If the control unit 23-2 determines in step Sd2 that the acquired received frame is the instruction to transmit the CTS (Sd2-Y), the control unit 23-2 instructs the wireless communication unit 22 to transmit a signal of the CTS frame through the antenna unit 21. Pursuant to instructions from the control unit 23-2, the wireless communication unit 22 generates the signal by modulating the CTS frame and transmits the signal through the antenna unit 21 (Sd3). Subsequently, the control unit 23-2 ends the processing if the processing is to be ended for power-off or the like (Sd4-Y). On the other hand, if the processing is to be continued without being ended (Sd4-N), the control unit 23-2 returns to the processing of step Sd1.

An instruction from the access point 10 to the guard terminal 20a or the like on the transmission timing for the CTS may be an instruction to transmit upon reception of the instruction, as illustrated in FIG. 16, or information indicating the transmission timing may be included in the instruction.

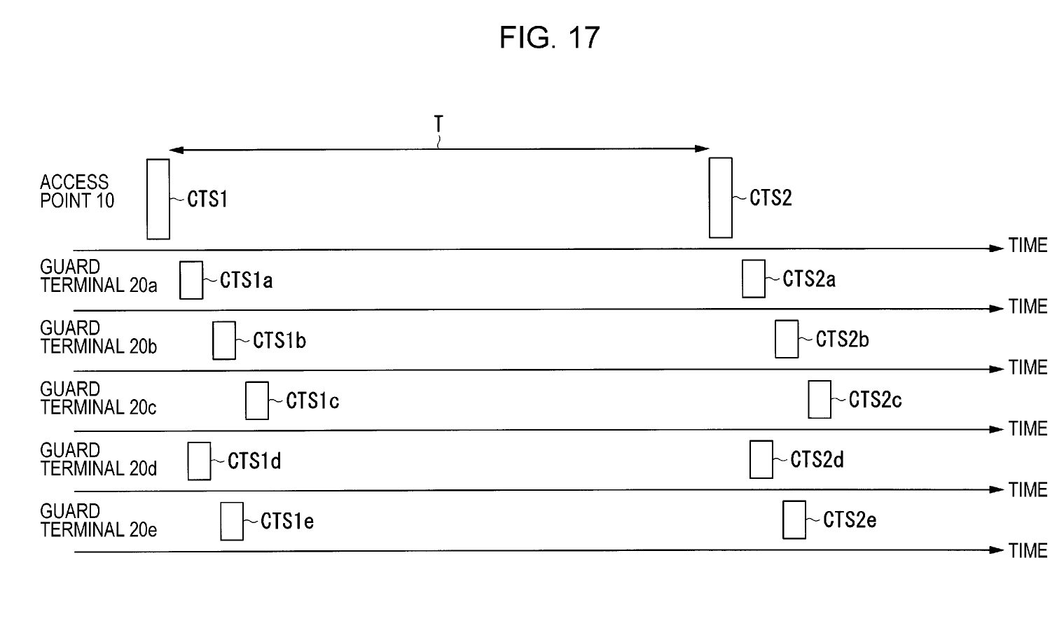

FIG. 17 is a timing diagram illustrating an example of the transmission timing for the CTS in the embodiment. In the example of FIG. 17, after transmitting the CTS frame CTS1 for the own apparatus, the control unit 13-2 of the access point 10 instructs the guard terminals 20a and 20d to simultaneously transmit the CTS frames CTS1a and CTS1d. Subsequently, the control unit 13-2 instructs the guard terminals 20b and 20e to simultaneously transmit CTS frames CTS1b and CTS1e. Finally, the control unit 13-2 instructs the guard terminal 20c to simultaneously transmit a CTS frame CTS1c. Thus the CTS frames CTS1a and CTS1d are simultaneously transmitted. Similarly, the CTS frames CTS1b and CTS1e are simultaneously transmitted.

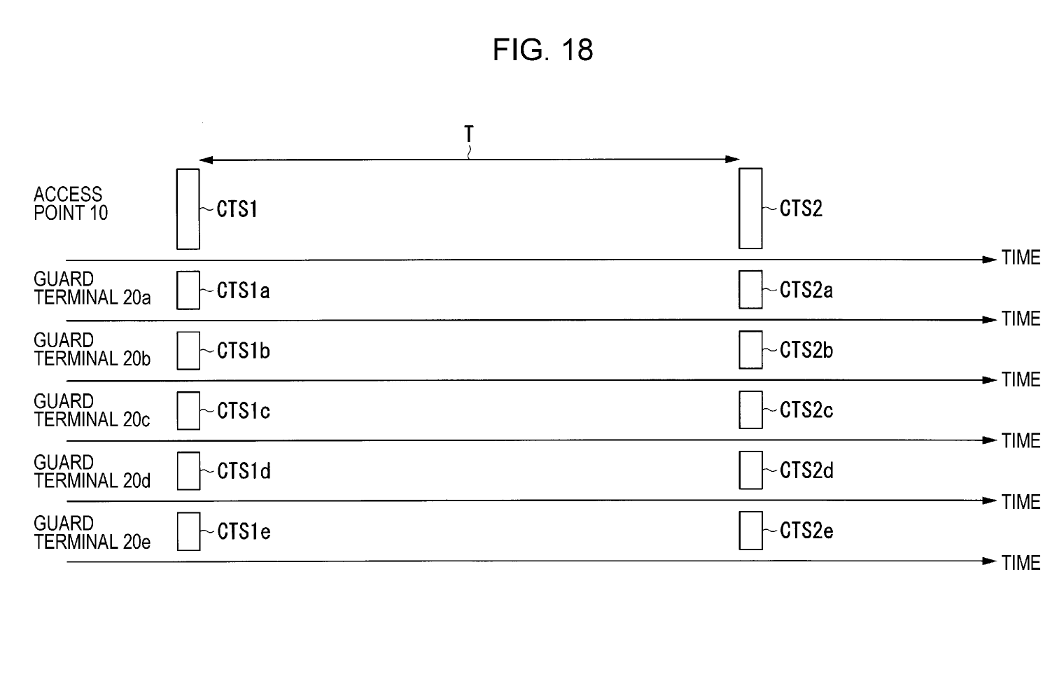

FIG. 18 is a timing diagram illustrating another example of the transmission timing for the CTS in the embodiment. In the example of FIG. 18, before transmitting the CTS frame CTS1 for the own apparatus, the control unit 13-2 of the access point 10 instructs the guard terminals 20a, 20b, 20c, 20d, and 20e to simultaneously transmit the CTS frames CTS1a, CTS1b, CTS1c, CTS1d, and CTS1e, respectively. Thus the CTS frames CTS1, CTS1a, CTS1b, CTS1c, CTS1d, and CTS1e are simultaneously transmitted. In cases where a plurality of apparatuses simultaneously transmit CTS frames in this manner, signals to be transmitted by the apparatuses may be made the same.

Though the access point 10 and the guard terminals 20a, 20b, 20c, 20d, and 20e are connected by the millimeter-wave communication in the embodiment, the access point and the guard terminals may be connected by another type of wireless communication or wired communication.

Beam forming may be used in the millimeter-wave communication between the access point 10 and the guard terminals 20a, 20b, 20c, 20d, and 20e.

In the embodiment as well, as with the second embodiment, monitoring terminals may be provided and the transmitted power in the guard terminals may be controlled based on the received power measured by the monitoring terminals.

In case where the time durations that are not dedicated but shared are provided for the dedicated channels EC as well by setting of the intervals between the iterated CTS frame transmissions longer than the duration T of prohibition against transmission that is set in the CTS, the access point 10 may use frequencies detected by the guard terminals 20a, 20b, 20c, 20d, and 20e as well, as the detection frequency for signals from other networks.

In the embodiment as well, the effects similar to those of the first embodiment can be obtained. Furthermore, the access point 10 controls the transmission timing for the CTS from the guard terminals 20a, 20b, 20c, 20d, and 20e. As a result, time taken for the transmission of the CTS can be shortened and overhead can be reduced.

Programs for implementing functions of the access point 10, the guard terminal 20a, and the terminal apparatus 40a in FIG. 1 and the access point 10, the guard terminal 20a, the monitoring terminal 30a, and the terminal apparatus 40a in FIG. 10 may be recorded in a computer readable recording medium and those apparatuses may be implemented by loading of the programs recorded on the recording medium into a computer system and execution of the programs. Herein, the “computer system” encompasses OS and hardware such as peripherals.

The “computer system” encompasses website providing environments (or displaying environments) on condition that a WWW system is used.

The term “computer readable recording medium” means a portable medium such as a flexible disk, a magneto-optical disk, a ROM, and a CD-ROM or a storage apparatus such as a hard disk built in a computer system. The term “computer readable recording medium” encompasses a medium that dynamically retains a program for a short time period, such as a communication line for a transmission of a program through a network such as the Internet or through communication lines such as telephone lines, and a medium that retains a program for a given time period, such as a volatile memory inside a computer system that serves as a server or a client for the former case. The programs may be intended for implementing portions of the functions described above and may be capable of implementing the functions described above by being combined with programs recorded previously in the computer system.

Functional blocks of the access point 10, the guard terminal 20a, and the terminal apparatus 40a in FIG. 1 and the access point 10, the guard terminal 20a, the monitoring terminal 30a, and the terminal apparatus 40a in FIG. 10, which have been described above, may separately be implemented as chips. Otherwise, some or all of the functional blocks may be integrated into a chip. A technique of such circuit integration is not limited to LSI but may be a technique of implementation as a dedicated circuit or a general-purpose processor. The circuit integration may be either hybrid or monolithic. The functions may be implemented partially as hardware and partially as software.

In case where a technique such as circuit integration that is capable of superseding LSI emerges with progress in semiconductor technology, integrated circuits based on the technique may be used.

Hereinabove, the embodiments of the invention have been described in detail with reference to the drawings. Specific configurations, however, are not limited to the embodiments but encompass modifications in design and the like without departing from the purport of the invention.

### DESCRIPTION OF REFERENCE NUMERALS

10 access point

11 antenna unit

12 wireless communication unit

13, 13-2 control unit

14 communication unit

15 antenna unit

16 millimeter-wave communication unit

20a, 20b, 20c, 20d, 20e guard terminal

21 antenna unit

22 wireless communication unit

23, 23-1, 23-2 control unit

24 communication unit

25 antenna unit

26 millimeter-wave communication unit

30a, 30b, 30c, 30d, 30e monitoring terminal

31 antenna unit

32 power measurement unit

33 communication unit

40a, 40b, 40c terminal apparatus

41 antenna unit

42 wireless communication unit

43 control unit

50 access point

60 terminal apparatus

100, 100-1 wireless communication system

1. A wireless communication system comprising:
a first access point; and
a guard terminal,
wherein the guard terminal transmits a signal for a reservation of a transmission medium after receiving a reservation medium signal transmitted from the first access point, and
the guard terminal transmits a signal for a reservation of the transmission medium after receiving a reservation medium signal transmitted from a second access point that is different from the first access point.

2. The wireless communication system according to claim 1, wherein the guard terminal preferentially transmits the signal for the reservation of the transmission medium that is based on the reservation medium signal transmitted from the first access point.

3. The wireless communication system according to claim 1, wherein the guard terminal sets a longer duration as a duration for which the medium is to be reserved in a transmission of the signal for the reservation of the transmission medium that is based on the reservation medium signal transmitted from the first access point than in a transmission of the signal for the reservation of the transmission medium that is based on the reservation medium signal transmitted from the second access point.

4. The wireless communication system according to claim 1, wherein the guard terminal transmits the signal for the reservation of the transmission medium that is based on the reservation medium signal transmitted from the first access point in a case of coincidence between transmission timing for the signal for the reservation of the transmission medium that is based on the reservation medium signal transmitted from the first access point and transmission timing for the signal for the reservation of the transmission medium that is based on the reservation medium signal transmitted from the second access point.

5. A guard terminal that is used in a wireless communication system including a first access point and the guard terminal,
wherein the guard terminal transmits a signal for a reservation of a transmission medium after receiving a reservation medium signal transmitted from the first access point, and
the guard terminal transmits a signal for a reservation of the transmission medium after receiving a reservation medium signal transmitted from a second access point that is different from the first access point.

6. The guard terminal according to claim 5, wherein the guard terminal preferentially transmits the signal for the reservation of the transmission medium that is based on the reservation medium signal transmitted from the first access point.

7. The guard terminal according to claim 5, wherein the guard terminal sets a longer duration as a duration for which the medium is to be reserved in a transmission of the signal for the reservation of the transmission medium that is based on the reservation medium signal transmitted from the first access point than in a transmission of the signal for the reservation of the transmission medium that is based on the reservation medium signal transmitted from the second access point.

8. The guard terminal according to claim 5, wherein the guard terminal transmits the signal for the reservation of the transmission medium that is based on the reservation medium signal transmitted from the first access point in a case of coincidence between transmission timing for the signal for the reservation of the transmission medium that is based on the reservation medium signal transmitted from the first access point and transmission timing for the signal for the reservation of the transmission medium that is based on the reservation medium signal transmitted from the second access point.
